(19) United States
(12) Patent Application Publication
(10) Pub. No.: US 2025/0386760 A1
(43) Pub. Date: Dec. 25, 2025

(54) BUCKET ASSEMBLY FOR SPREADING MATERIAL

(71) Applicant: East Coast Facilities, Inc., Allentown, PA (US)

(72) Inventor: Josiah Gámez, Allentown, PA (US)

(21) Appl. No.: 19/248,190

(22) Filed: Jun. 24, 2025

Related U.S. Application Data
(60) Provisional application No. 63/663,519, filed on Jun. 24, 2024.

(51) Int. Cl. A01C 15/00

(52) U.S. Cl. CPC A01C 15/006

(57) ABSTRACT

A bucket assembly for spreading material is disclosed. The bucket assembly includes a front panel, a rear panel, a left-side panel, a right-side panel, and a base panel together defining a receptacle of the bucket assembly. Further, the bucket assembly includes at least one outlet positioned in the receptacle and a plurality of bottom ports extending along a width of the receptacle. An auger is configured to rotate in a first direction and a second direction opposite the first direction. During rotation in the first direction, the auger directs material towards the plurality of bottom ports. During rotation in the second direction, the auger directs material within the receptacle towards the at least one outlet.

### BACKGROUND

This disclosure relates to material spreader equipment, and an in particular to a bucket assembly for spreading material.

### SUMMARY

In one embodiment, a bucket assembly for spreading material is disclosed. The bucket assembly includes a front panel, a rear panel, a left-side panel, a right-side panel, and a base panel together defining a receptacle of the bucket assembly. Further, the bucket assembly includes at least one outlet and a plurality of bottom ports extending along a width of the receptacle. An auger is configured to rotate in a first direction and a second direction opposite the first direction. During rotation in the first direction, the auger directs material towards the plurality of bottom ports. During rotation in the second direction, the auger directs material within the receptacle towards the first and second outlets.

### BRIEF DESCRIPTION OF THE DRAWINGS

FIG. 1 illustrates a perspective view of a bucket assembly.

FIG. 2 illustrates a top view of the bucket assembly of FIG. 1.

FIG. 3 illustrates a front perspective view of the bucket assembly of FIG. 1.

FIG. 4 illustrates a bottom perspective view of the bucket assembly of FIG. 1.

FIG. 5 illustrates a top sectional view of the bucket assembly of FIG. 1.

FIG. 6 illustrates a left-side view of the bucket assembly of FIG. 1.

FIG. 7 illustrates a right-side view of the bucket assembly of FIG. 1.

FIG. 8 illustrates a top view of an auger of the bucket assembly.

FIG. 9 illustrates a top view of a second auger of the bucket assembly.

FIG. 10 illustrates a perspective view of an auger of the bucket assembly.

FIG. 11 illustrates a perspective view of a grate of the bucket assembly.

### DESCRIPTION

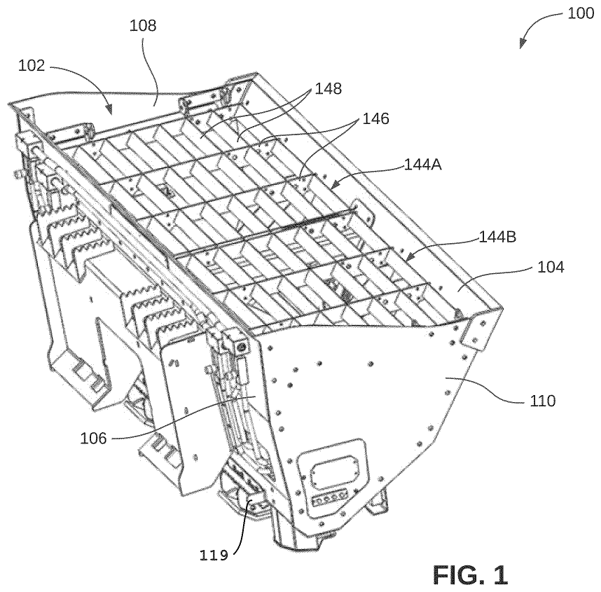

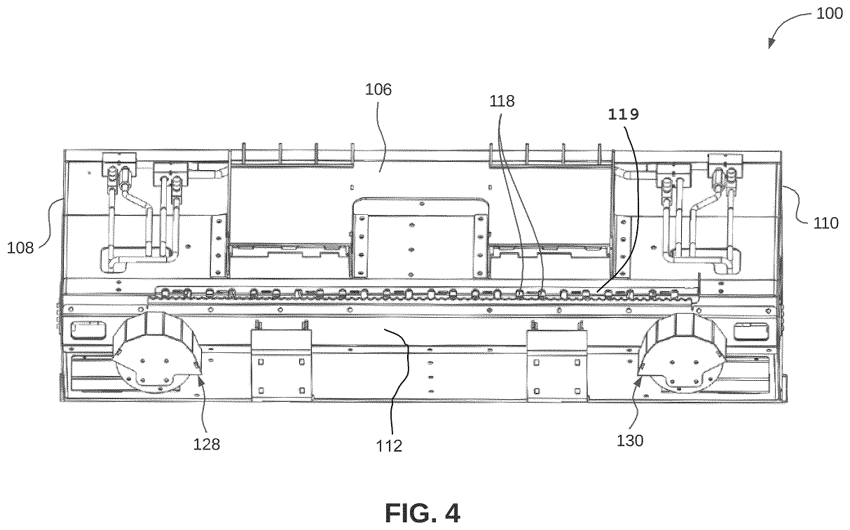

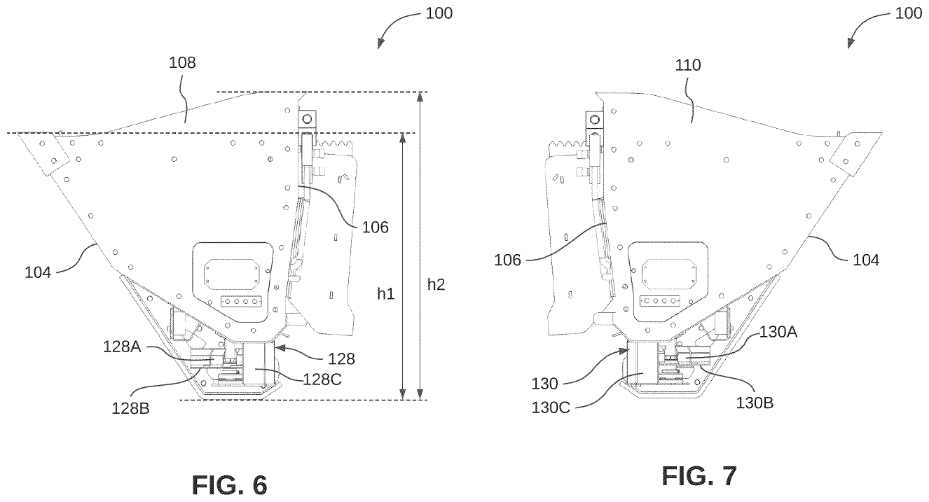

Referring to FIGS. 1-7, various different views of a bucket assembly 100 are illustrated, in accordance with embodiments of the present disclosure. The bucket assembly 100 includes a receptacle 102 defined by interior surfaces of a front panel 104, a rear panel 106, a left-side panel 108, a right-side panel 110, and a base panel 112. As shown in FIGS. 1-2 and 6-7, the front panel 104 may be configured to include a substantially flat interior surface, and inclined (i.e., obliquely oriented) at an angle relative to a vertical orientation (i.e., when rear panel 106 is generally disposed in an up and down direction perpendicular to the ground as illustrated in FIGS. 6 and 7). In one embodiment, the angle for front panel 104 is selected to form a chute. This inclination of the chute may assist in directing the material in the receptacle 102 towards a bottom of the receptacle 102 (i.e., contacting base panel 112).

Rear panel 106 includes a substantially flat interior surface that is positioned opposite the interior surface of front panel 104. Rear panel 106 can further be configured to be coupled at a front or rear side of a work machine (e.g., a skid steer loader). To this end, the rear panel 106 may include a coupling mechanism, for example one or more brackets, to allow the bucket assembly to be coupled to the work machine.

Each of the left-side panel 108 and the right-side panel 110 may include a substantially flat interior surface and positioned to extend between the front panel 104 and the rear panel 106 and opposite to one another. The left-side panel 108 and the right-side panel 110 define the left and right sides of the receptacle 102 of the bucket assembly 100.

In one embodiment, each of the front panel 104, the rear panel 106, the left-side panel 108, the right-side panel 110, and the base panel 112 are manufactured from a rigid material such as a metal, an alloy (for example, steel), or a composite material, etc. The front panel 104, the rear [panel 106, the left-side panel 108, the right-side panel 110, and the base panel 112 are connected to define the receptacle 102. In particular, the front panel 104 may be attached to base panel 112 and the left-side panel 108 and the right-side panel 110. Further, the rear panel 106 may be attached to the base panel 112, and the left-side panel 108 and the right-side panel 110. By way of an example, the front panel 104, the rear panel 106, the left-side panel 108, the right-side panel 110, and the base panel 112 may be attached to each other via welding or using fasteners (e.g. screws, nut-bolt assemblies, rivets, etc.).

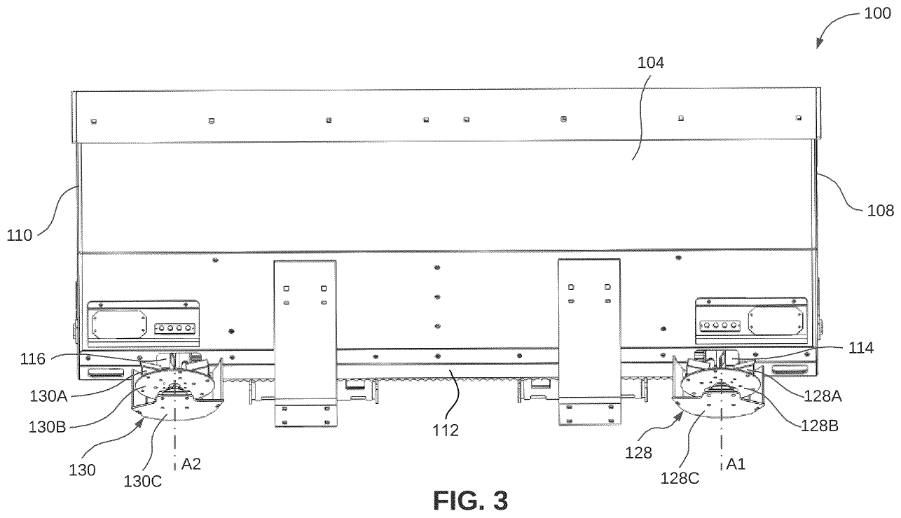

As shown in FIG. 3, the bucket assembly 100 may include a first outlet 114 positioned proximate the left-side panel 108 and a second outlet 116 positioned proximate the right-side panel 110. In one embodiment, the first outlet 114 and the second outlet 116 are formed in the base panel 112. First outlet 114 and second outlet 116 are sized to allow material within the receptacle 102 to exit the receptacle 102.

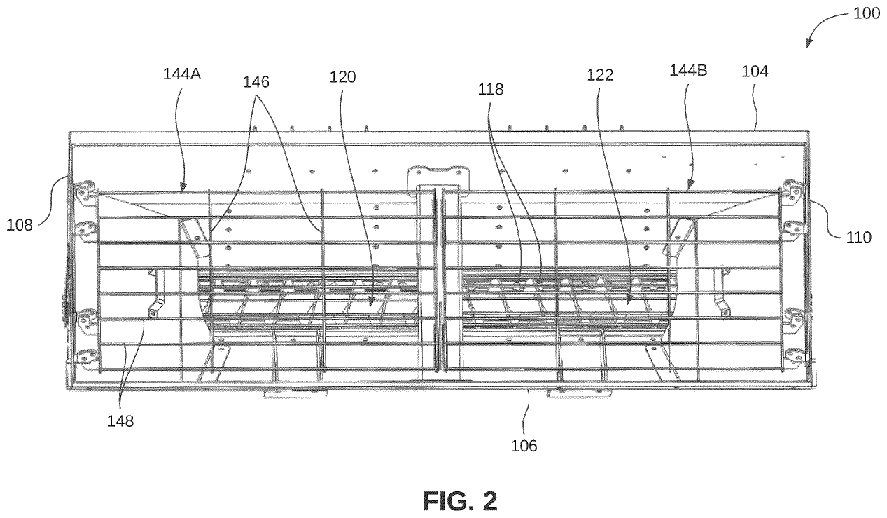

As shown in FIGS. 2 and 4-5, the bucket assembly 100 includes a plurality of bottom ports 118 extending along a width of the receptacle 102 (it should be noted that a limited number of bottom ports 118 are delineated in FIGS. 2, 4, 6 for the sake of brevity; however, any number of bottom ports 118 can be used as desired). In the embodiment illustrated, 24 bottom ports extend along a width of receptable 102 and are positioned in rear panel 106 at a bottom thereof. In other embodiments, a number of bottom ports is greater than 5, greater than 10, greater than 15, greater than 20. The plurality of bottom ports 118 are formed on rear panel 106 of receptacle 102 to allow material within receptacle 102 to exit outside of the receptacle 102. In the embodiment illustrated, a gate 119 is mounted to rear panel 106 and is slidable relative to rear panel 106. In an open position, gate 119 allows material to pass through the plurality of bottom ports 118. In a closed position, gate 119 covers the plurality of ports 118 to prevent material from exiting receptable 102. In the illustrated embodiment, gate 119 includes a tab to assist a user in sliding gate 119 relative to rear panel 106. In other embodiments, a powered mechanism can operate to slide gate 119 relative to rear panel 106.

As explained herein, bucket assembly 100 can operate in a broadcast mode, wherein material exiting receptacle 102 is broadcast away from the bucket assembly 100, and a drop spreader mode, wherein material exiting receptacle 102 is dropped below bucket assembly 100. When bucket assembly 100 operates in a broadcast mode, gate 119 is in a closed position and material exits receptacle 102 through first and second outlets 114 and 116 (e.g., positioned within bottom panel 112). When bucket assembly 100 operates in a drop mode, gate 119 is in an open position and material exits receptacle 102 through the plurality of bottom ports 118.

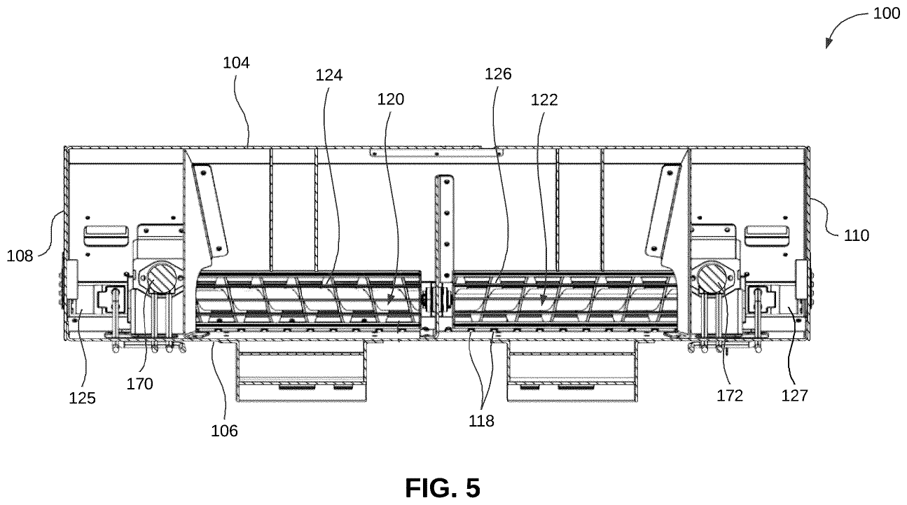

As shown in FIGS. 2 and 5, bucket assembly 100 further includes augers 120 and 122. In other embodiments, bucket assembly 100 can include a single auger extending along a width of the receptacle. Auger 120 is positioned proximate base panel 112 and includes a helical flight 124 extending along a length of the auger 120. In one embodiment, helical flight 124 is a spiral-shaped, screw-like continuous or segmented blade wrapping around a central shaft of the auger 120. The helical flight 124 may be made from a durable material such as steel or stainless steel. As auger 120 rotates, helical flight 124 moves material along the auger 120. The auger 120 may be configured to rotate in a first direction (for example, clockwise) and a second, opposite direction (for example, counter-clockwise) about an axis of rotation for the auger 120. During rotation in the first direction, the auger 120 directs material within the receptacle 102 towards a center of the receptacle 102 (i.e., away from side panel 108). Material is then urged towards base panel 112 and toward the plurality of bottom ports 118. As a result, material is dropped through the plurality of bottom ports 118 to the ground vertically. During rotation in the second direction, the auger 120 directs material within the receptacle 102 towards the first outlet 114. Specifically, material within the receptacle 102 is directed towards left-side panel 108 and exits receptacle 102 via the first outlet 114. The angle and pitch of the helical flight 124 may determine the efficiency and rate at which material is moved. For example, a steeper pitch may move material faster but may require more power.

In order to rotate auger 120, bucket assembly 100 includes a motor 125 (e.g., hydraulic, electric) coupled to the auger 120 to thereby rotate the auger 120 in the first and second directions. In the embodiment illustrated, motor 125 is directly coupled to auger 120, but in other embodiments motor 125 can be coupled to auger through a gear box or chain. In an example embodiment, the motor may be positioned proximate the left-side panel 108 and within the receptacle 102 and directly coupled with the auger 120. In alternate embodiments, the motor may be positioned outside the receptacle 102 and can be coupled to the auger 120 via a belt drive or other drive mechanism.

Bucket assembly 100 further includes a second auger 122 capable of operating independently of auger 120. Similar to auger 120, auger 122 is positioned proximate base panel 112 of the receptacle 102 and includes a helical flight 126 that extends along a length of the second auger 122. The helical flight 126 may have a similar construction as helical flight 124 of the auger 120, however, the spiral of the helical flight 126 of the second auger 122 can be configured in an opposite direction as compared to the spiral of the helical flight 124 of auger 120. Second auger 122 is configured to rotate in a first direction and a second direction. In one embodiment, when auger 120 is rotating clockwise, second auger 122 can rotate counter-clockwise. In any event, during rotation of auger 122 in a first direction, the second auger 122 directs material within the receptacle 102 towards a center of receptacle 102. In turn, material is directed toward the plurality of bottom ports 118. During rotation in the second direction, the second auger 122 directs material within the receptacle 102 towards second outlet 116. Material exits receptacle 102 through second outlet 116. During operation, auger 120 and second auger 122 can be configured to rotate to direct material within the receptacle 102 towards left-side panel 108 and right-side panel 110, respectively, so that material exits receptacle 102 via first outlet 114 and second outlet 116, respectively.

Second auger 122 can be rotated by a motor 127. In an example embodiment, the motor powering the second auger 122 can be positioned proximate the right-side panel 110 and within the receptacle 102 and directly coupled with the second auger 122 or may be positioned outside the receptacle 102 coupled to the second auger 122 via a belt drive.

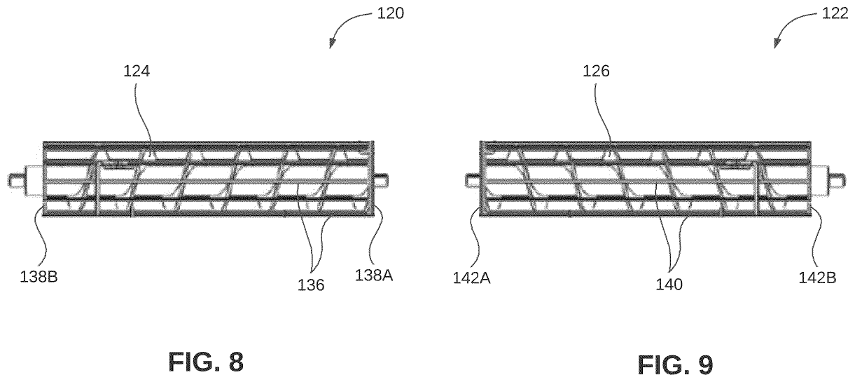

Referring additionally to FIGS. 8-10, auger 120 includes a plurality of bars 136 that extend along a length of the auger 120 and positioned at a maximum outer dimension of the helical flight 124. In another embodiment, the plurality of bars 136 can be positioned inboard of the maximum outer dimension. Further, auger 120 includes first and second end plates 138A, 138B. The plurality of bars 136 extend from the first end plate 138A to the second end plate 138B, with one end of each of the plurality of bars 136 attached to first end plate 138A and the other end attached to second end plate 138B, thereby forming a cage-like structure around helical flight 124. In one embodiment, each of the first and second end plates 138A, 138B defines a circular profile locating the plurality of bars 136 around a circumferential periphery of the first and second end plates 138A, 138B.

The plurality of bars 136 and end plates 138A, 138B can be manufactured from a rigid material such as steel or stainless steel. The plurality of bars 136 can be attached to the first end plate 138A and the second end plate 138B via welding. In one embodiment, end plates 138A and 138B include recesses or notches to receive the plurality of bars 136. During rotation of auger 120, the plurality of bars 136 rotate along with auger 120, creating a surface that assists in breaking large material particles into smaller particles before contacting helical flight 124 of the auger 120. The breaking of the large material particles into smaller particles can enable the auger 120 to direct the material towards the first and second outlets 114, 116 or the plurality of bottom ports 118 more effectively.

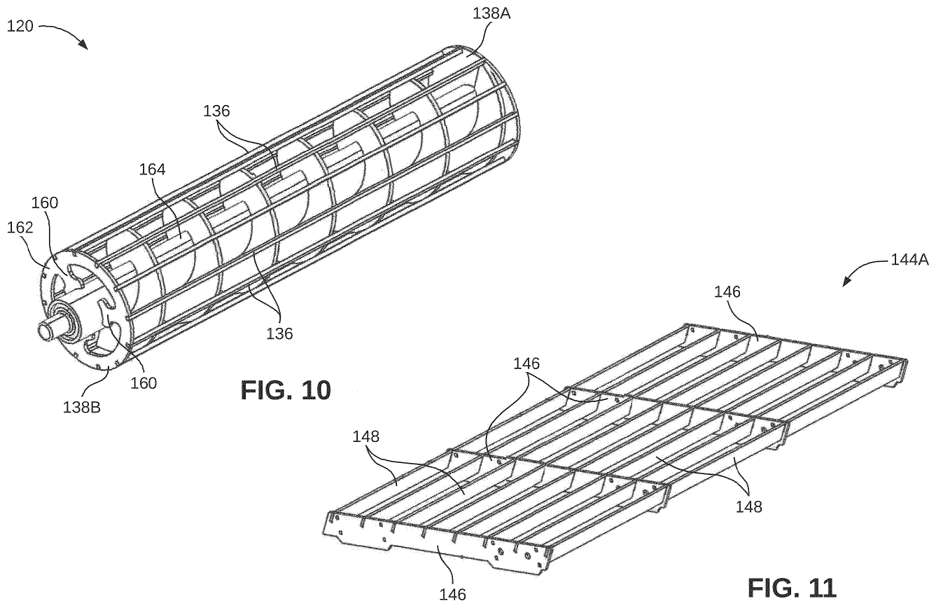

With reference to the embodiment illustrated in FIG. 10, end plate 138B is in an open configuration that includes a plurality of arms 160 extending inwardly from an outer peripheral portion 162 of the end plate 138B. The plurality of arms 160 are mounted about a central shaft 164 of auger 120. During rotation of auger 120 that moves material toward plate 138B, material can pass between each of the plurality of arms 160, allowing material to pass to outlet 114. End plate 138A is in a closed configuration that prevents material flowing therethrough, only including a central aperture to accommodate central shaft 164. As such, during rotation of auger 120 that moves material toward 138A, material is prevented from passing through end plate 138A and is directed to the plurality of ports 118.

Second auger 122 is similarly constructed to auger 120 and includes a plurality of bars 140 extending along a length of the second auger 122 and positioned at a maximum dimension of helical flight 126. Second auger 122 includes first and second end plates 142A, 142B that are similarly structured to end plates 138A and 138B, respectively, as discussed above. The plurality of bars 140 extend from first end plate 142A to second end plate 142B. In particular, one end of each of the plurality of bars 140 is attached to first end plate 142A and the other end is attached to the second end plate 142B, forming a cage-like structure around the helical flight 126. The plurality of bars 140 rotate along with second auger 122, creating a surface to assist in breaking large material particles into smaller particles before contacting helical flight 126 of the second auger 122.

In order to broadcast material (i.e., bucket assembly 100 operating in a broadcast mode), bucket assembly 100 includes a first spinner 128 and a second spinner 130 positioned to receive and broadcast material exiting first and second outlets 114, 116, respectively. As mentioned above, rotation of the auger 120 and the second auger 122 can direct material towards first and second outlets 114, 116, respectively. In the illustrated embodiment, first and second spinners 128, 130 are positioned immediately below first and second outlets 114, 116, respectively, to receive material after it passes through the first and second outlets 114, 116, to thereby dispense material radially outwardly upon rotation of first and second spinners 128, 130, respectively.

First and second spinners 128, 130 include a circular plate and a plurality of radially-extending vanes. First spinner 128 includes a circular bottom plate 128A and a plurality of radially-extending vanes 128B. First spinner 128 further includes a deflector 128C that directs material contacting vanes 128B. During operation, first spinner 128 rotates about a central axis A1 perpendicular to base panel 112 of receptacle 102. Material exiting outlet 114 contacts circular bottom plate 128A and the plurality of radially-extending vanes 128B impart a centrifugal force that radially disperses material from the first spinner 128. Deflector 128C directs material in a direction toward front panel 104 to prevent material from being broadcast toward a machine carrying bucket assembly 100.

Similarly, second spinner 130 includes a circular bottom plate 130A, a plurality of radially-extending vanes 130B and a deflector 130C. During operation, second spinner 130 rotates about a central axis A2 perpendicular to base panel 112 of receptacle 102. Material exiting second outlet 116 contacts circular bottom plate 130A and the plurality of radially-extending vanes 130B impart a centrifugal force that radially disperses material from the second spinner 130. Deflector 130C directs material in a direction toward front panel 104 to prevent material from being broadcast toward a machine carrying bucket assembly 100.

Each of the first and second spinner 128, 130 can be driven by a respective motor 170, 172. For example, the motors 170, 172 can be mounted on the bucket assembly 100 and positioned within the receptacle 102 and attached to the first and second spinner 128, 130. In one embodiment, each of the first and the second spinner 128, 130 are configured to operate independently.

As shown in FIGS. 1-2, bucket assembly 100 includes side-by-side grates 144A and 144B positioned at a top of the receptacle 102 and extending from left-side panel 108 to right-side panel 110. In an alternative embodiment, a single grate can extend along a width of the receptacle 102. With additional reference to FIG. 11, grate 144A includes a first plurality of bars 146 extending along a depth of the receptacle 102 from the front panel 104 to the rear panel 106, and parallel to each other. Grate 144A includes a rectangular frame defining a periphery, with each of the first plurality of bars 146 arranged within the periphery of the frame. Each of the first plurality of bars 146 can define a flat profile oriented along a vertical axis (e.g., parallel to axis A1 in FIG. 3).

Grate 144A also includes a second plurality of bars 148 extending along a width of the receptacle 102. The second plurality of bars 148 include a flat profile and extend parallel to one another. Each of the second plurality of bars 148 may be arranged within the periphery of the frame. As illustrated, the second plurality of bars 148 are oriented oblique to a depth of the receptacle 102 and to the plurality of bars 146. In addition, each of the second plurality of bars 148 is aligned parallel to front panel 104 of the receptacle 102, such that a flat side of each of the second plurality of bars 148 is parallel to front panel 104 of the receptacle 102. This oblique orientation of the second plurality of bars 148 can assist in directing flow of material entering through grates 114A and 114B. For example, in some instances, material is positioned in a pile on the ground prior to being positioned in the receptacle 102. Bucket assembly 100 can be tilted and positioned to scoop material from the pile into the receptacle 102. Orientation of the plurality of bars 148 parallel to front panel 104 assist in directing material from the pile into the receptacle 102.

In addition, with reference to FIG. 6, a height h2 of the rear panel 106 can extend above a height h1 of the front panel 104. When bucket assembly 100 is mounted to a machine so rear panel 106 of bucket assembly 100 is aligned vertically, then the height h2 of the rear panel 106 extends above the height h1 of the front panel 104. Accordingly, the rear panel 106 extends above grates 144A and 144B. The greater height of rear panel 106 with respect to front panel 104 assists in directing material into the receptacle 102 when the material is being scooped into receptacle 102. Additionally, the greater height prevents some spillage of material while the material is scooped into receptacle 102.

A bucket assembly for spreading material is disclosed herein. The above bucket assembly can include one or more augers, each auger being able to rotate in opposite directions about an axis. During rotation in one direction, the auger(s) can direct material within the receptacle towards a plurality of bottom ports to cause dropping of material via a plurality of bottom ports. During rotation in an opposite direction, the auger(s) can direct material within the receptacle towards one or more outlet(s) to broadcast material, for example using a spinner positioned to impart a centrifugal force on material exiting the one or more outlets. As such, the bucket assembly can be used for both drop spreading and broadcasting of the material.

In a further embodiment, the auger(s) can include a plurality of bars attached thereto via first and second end plates. The plurality of bars rotate along with the auger(s) to assist in breaking large material particles into smaller particles before contacting a helical flight of the auger(s).

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A bucket assembly for spreading material, the bucket assembly comprising:
a front panel, a rear panel, a left-side panel, a right-side panel, and a base panel together defining a receptacle of the bucket assembly;
at least one outlet positioned proximate the base panel;
a plurality of bottom ports extending along a width of the receptacle; and
an auger configured to rotate in a first direction and a second direction opposite the first direction, wherein during rotation in the first direction, the auger directs material towards the plurality of bottom ports, and wherein during rotation in the second direction, the auger directs material within the receptacle towards the at least one outlet.

2. The bucket assembly of claim 1, wherein the plurality of bottom ports are defined on the rear panel of the receptacle.

3. The bucket assembly of claim 1, wherein the at least one outlet is defined on the base panel.

4. The bucket assembly of claim 1, wherein the auger is rotated by a motor.

5. The bucket assembly of claim 1, further comprising a second auger configured to operate independently of the first-mentioned auger.

6. The bucket assembly of claim 1 further comprising:
at least one spinner positioned to receive and broadcast material from the at least one outlet.

7. The bucket assembly of claim 6 further comprising:
a deflector positioned about the spinner.

8. The bucket assembly of claim 6, wherein the spinner is driven by a motor.

9. The bucket assembly of claim 6, further comprising a second spinner.

10. The bucket assembly of claim 1, wherein the auger comprises a helical flight.

11. The bucket assembly of claim 10, wherein the auger comprises a plurality of bars extending along a length of the auger and positioned at a maximum dimension of the helical flight.

12. The bucket assembly of claim 11, wherein the auger further includes first and second end plates, the plurality of bars extending from the first end plate to the second end plate.

13. The bucket assembly of claim 1, further comprising:
a grate positioned at a top of the receptacle, comprising:
a plurality of bars extending along the width of the receptacle, wherein each of the plurality of bars comprises a front surface aligned parallel to the front panel of the receptacle.

14. The bucket assembly of claim 1, further comprising:
a grate positioned at a top of the receptacle, comprising:
a first plurality of bars extending along a depth of the receptacle; and
a second plurality of bars extending along a width of the receptacle, wherein the second plurality of bars are each oriented oblique to the depth.

15. The bucket assembly of claim 1, wherein when the rear panel extends in a vertical orientation, a height of the rear panel extends above a height of the front panel.

16. A method of operating a bucket assembly, comprising:
positioning an auger within a receptacle of the bucket assembly;
rotating the auger in a first direction to direct material in the bucket assembly to a plurality of ports in the receptacle;
rotating the auger in a second direction opposite the first direction to direct material in the bucket assembly to an outlet in the receptacle; and
broadcasting material from the outlet using a spinner.
